(19) United States
(12) Patent Application Publication
(10) Pub. No.: US 2017/0103456 A1
(43) Pub. Date: Apr. 13, 2017

(54) SYSTEM AND METHOD FOR LOAN VALIDATION AND RECOVERY SYSTEM FOR MARKETPLACE INVESTORS

(71) Applicant: GDR ACQUISITION COMPANY LLC, Wilmington, DE (US)

(72) Inventors: Mark Andrew PARSELLS, Wilmington, DE (US); Robert Wilson BROWN, Middletown, DE (US); Thomas D. VEALE, Wilmington, DE (US)

(21) Appl. No.: 15/292,658

(22) Filed: Oct. 13, 2016

Related U.S. Application Data
(60) Provisional application No. 62/240,839, filed on Oct. 13, 2015.

(51) Int. Cl. G06Q 40/02; G06Q 40/06

(52) U.S. Cl. CPC G06Q 40/025; G06Q 40/06; G06Q 50/18

(57) ABSTRACT

The process and system as described herein provides for unique tracking and validation processes that may enable investors in loans originated through online or marketplace lending platforms to access independent validation of account information for each loan in a portfolio of loans at origination and on an ad hoc basis after origination.

### CROSS REFERENCE TO RELATED APPLICATIONS

This application claims benefit and priority to U.S. Provisional Patent Application No. 62/240,839, filed Oct. 13, 2015, the disclosure of which is incorporated by reference herein in its entirety.

### BACKGROUND OF THE DISCLOSURE

1.0 Field of the Disclosure

The present disclosure relates to a method, a system and a computer program for loan validation and recovery for marketplace investors, among other things.

2.0 Related Art

Marketplace Lending is a fast growing segment of consumer and small business lending involving the funding of individual loans through investment funds provided by individuals and institutional investors. A primary servicing firm, often the marketing firm that may be known to the consumer, may be responsible for servicing the underlying account and for forwarding funds generated from borrowers to pay investors the principal and interest in the investment agreement. Transactions in marketplace lending may involve multiple loan-level transfers of ownership, collection rights and investor rights over the life cycle of a loan but there is a significant lack of ongoing transparency and a lack of ability to access personally identifiable data and documents supporting the loan or collateral when the asset is pledged as collateral to credit providers. When ownership may be transferred, there is no continuity of loan-level documentation and little confidence that the documentation is accurate or complete. Moreover, the consumer may have little or no access to the same documentation as market place lenders, vendors or investors, so they may be at a disadvantage.

### SUMMARY OF THE DISCLOSURE

In one aspect, the present “Loan Validation and Recovery” (LVR) process and system (LVRS) as described herein addresses Marketplace Lending which is a fast growing segment of consumer and small business lending involving the funding of individual loans through investment funds provided by individuals and institutional investors. A primary servicing firm, often the marketing firm may be known to the consumer, and may be responsible for servicing the underlying account and for forwarding funds generated from borrowers to pay investors the principal and interest in the investment agreement. Transactions in Marketplace Lending may involve multiple transfers of ownership, collection rights and investor rights, and therefore a need for ongoing transparency and continuous access to data and documents supporting the loan collateral over the life cycle of a loan. LVRS enables Marketplace Lenders (“MPLs”) to provide investors access to a one-stop independent data and document repository to validate account-level information and, if needed, provide confidence to investors that the data and documents could be securely and efficiently moved to a backup servicer.

In one aspect, individual and institutional investors benefit from LVRS by receiving independent validation that each loan in a portfolio of loans is supported by the necessary data, documents and representations and warranties from the MPL without requiring the investor to access personally identifiable information (PII) on the account-level data or documents.

In one aspect, MPLs may be primarily marketing and servicing firms that connect borrowers (or debtors) with investors. The MPL may provide borrowers with access to an online loan application and applies a credit risk analysis to project the riskiness of a loan. The loans may be presented by the MPL to its network of investors including individual and institutional investors. When a loan commitment is completed, a separate chartered Bank may originate the loan. After a short period of time, often 2 days, the loan may be re-purchased from the Bank by the investors. The MPL may be the servicer of the loan and may provide services including processing borrower payments, collecting past due accounts and providing customer service to the borrower. The servicer receives fees from the borrower's payments and returns principal and interest to the investors in accordance with the terms of the investment agreement.

In one aspect, usually an important concept in this market is the ability of investors to purchase whole or fractional shares in individual loans. For example, individual investors may commit as little as $25 toward a specific loan that may have a total loan value of $5000 or more. Prior to investing, investors can view certain anonymized attributes about a loan application.

In one aspect, the LVRS of this disclosure may be deployed by the MPL to efficiently bridge the gap between an investor's need for transparency and validation with the market and regulatory need to protect confidentiality of an individual borrower's PII. LVRS enables access to supporting documents for all MPL investors, i.e., LVRS supports account-level validation needs of institutional investors purchasing large numbers of whole loans as well as individual investors purchasing small numbers of fractional loans.

In one aspect, a system for loan validation and recovery includes a server comprising a computer and connected to a network, a database accessible by the server, an account creation subsystem executing on the server that permits a marketplace lender (MPL) to establish or access at least one account related to at least one debt instrument of a debtor and to supply for the at least one account supporting data related to the at least one debt instrument, the account and supporting data stored in the database along with a GDR number (GDRN) for the at least one account, a report generation subsystem executing on the server that permits a marketplace lender to electronically sign a report generated by the report generation subsystem affirming information within the generated report for the at least one account, an account transfer subsystem executing on the server that permits a marketplace lender or owner of a loan to transfer ownership of the at least one account to a debt buyer, investor or trust, and an account access subsystem executing on the server that permits the marketplace lender, the debtor, an authorized vendor and an investor to access the database and the at least one account. In the system, a plurality of: MPL, debtor, an authorized vendor and the investor may access the database simultaneously. The authorized vendor and the investor may access the at least one account only after being authorized at the server by the marketplace lender. The market place lender may electronically sign the report to affirm at least one of or all the following affirmations:
a) that the marketplace lender or original creditor is the sole legal, beneficial and equitable owner of each of the referenced debt instruments and has good and marketable title for each referenced debt instrument,
b) each debt instrument is free and clear of any lien, pledge, charge, claim, security interest or other encumbrance,
c) the MPL or original creditor has not sold, assigned or otherwise transferred any right in or to any debt instrument,
d) the MPL or original creditor has not pledged any debt instrument as collateral for any debt or other purpose except as agreed to by the debt buyer,
e) no borrower of the debt instrument has asserted any defense, counter claim, offset or dispute,
f) each debt instrument is free from any defense, offset, counterclaim or recoupment that could be asserted by the debtor, and
g) the debt instrument is not in default or delinquent by more than a predetermined time period.

Moreover, the MPL may authorize at the server an investor to have access to the at least one account and supporting data without access to personally identifiable information of the debtor. The system may further comprise a document handler subsystem that permits a MPL to upload new documents to the database and to link the new documents to the at least one account. The account access subsystem may permit the investor to retrieve the new documents after the MPL has uploaded the new documents to the database. The at least one account may comprises a plurality of accounts. The supporting document data may comprises one or more of:
a) a Loan Agreement,
b) a Non-Negotiable Promissory Note,
c) a Terms of Use document,
d) a Borrower Membership Agreement,
e) a Truth in Lending Disclosure,
f) a Borrower Credit Profile Authorization,
g) a Borrower Bank Account Verification.
h) an Applicable Privacy Notice,
i) a Security Agreement,
j) a Personal Guaranty, and
k) a Uniform Commercial Code (UCC) Financing Statement.

In one aspect, a computer program product embodied on a non-transitory storage medium that, when read and executed by a computer, performs the steps for loan validation and recovery, comprising creating by marketplace lender (MPL) over a network at a server at least one account related to at least one debt instrument of a debtor and receiving at the server supporting data related to the at least one debt instrument, the account and supporting data stored in a database along with a GDRN for the at least one account, receiving an electronic signature at the server that indicates that a MPL affirms information within a generated report for the at least one account, transferring ownership at the server of the at least one account to a debt buyer, investor or trustee, and permitting the marketplace lender, an authorized vendor and an investor to access the at least one account in the database. A plurality of the MPLs, an authorized vendor and the investor may access the database simultaneously. The authorized vendor and the investor may access the at least one account only after being authorized at the server by the marketplace lender or owner. The electronic signature may indicate at least one of the following affirmations:
a) that die MPL or original creditor is the sole legal, beneficial and equitable owner of each of the referenced debt instruments and has good and marketable title for each referenced debt instrument;
b) each debt instrument is free and clear of any lien, pledge, charge, claim, security interest or other encumbrance;
c) the MPL or original creditor has not sold, assigned or otherwise transferred any right in or to any debt instrument;
d) the MPL or original creditor has not pledged any debt instrument as collateral for any debt or other purpose except as agreed to by the debt buyer;
e) no borrower of the debt instrument has asserted any defense, counter claim, offset or dispute;
f) each debt instrument is free from any defense, offset, counterclaim or recoupment that could be asserted by the debtor; and
g) the debt instrument is not in default or delinquent by more than a predetermined time period.

Moreover, the electronic signature may indicate affirmation of each of the affirmations. The computer program product may further perform receiving at the server an authorization from the MPL that authorizes the investor to have access to the at least one account and the supporting data without access to personally identifiable information of the debtor. The computer program product further comprise receiving new documents at the server from the MPL to the database and to link the new documents to the at least one account. The computer program product may further comprises permitting the investor to retrieve the new documents from the server after the MPL has uploaded the new documents to the database. The at least one account may comprise a plurality of accounts. Moreover, the supporting document data comprise one or more of:
a) a Loan Agreement;
b) a Non-Negotiable Promissory Note;
c) a Terms of Use document,
d) a Borrower Membership Agreement;
e) a Truth in Lending Disclosure;
f) a Borrower Credit Profile Authorization;
g) a Borrower Bank Account Verification;
h) an Applicable Privacy Notice;
i) a Security Agreement;
j) a Personal Guaranty; and
k) a Uniform Commercial Code (UCC) Financing Statement.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is an example flow diagram of registration related to loan validation and recovery for marketplace investors, according to principles of the disclosure.

FIG. 2 is an example block diagram and example process for loan validation and recovery for marketplace investors, according to principles of the disclosure.

FIG. 3 is an example block diagram of an illustrative computer-based system suitable for performing the processes of FIGS. 1 and 2, configured according to principles of the disclosure.

FIG. 4 is an example block diagram of software system configured to provide loan validation and recovery for marketplace investors, according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, cell phone, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. At least one application may include, but is not limited to, for example, an application program that can accept connections to service requests from clients by sending back responses to the clients. The database may be configured to run at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The terms “borrower” and “debtor” are equivalent.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other non-transitory storage medium from which a computer can read.

Various forms of computer readable media may be involved in carrying sequences of instructions to a computer. For example, sequences of instructions (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

In one aspect, the unique lending processes provided by the system and methods herein may enable investors in loans originated through online or marketplace lending platforms to access independent validation of account information for each loan in a portfolio of loans at origination and on an ad hoc basis after origination.

Marketplace Lending is a fast growing segment of consumer and small business lending involving the funding of individual loans through investment funds provided by individuals and institutional investors. A primary servicing firm, often the marketing firm that may be known to the consumer, may be responsible for servicing the underlying account and for forwarding funds generated from borrowers to pay investors the principal and interest in the investment agreement. Transactions in marketplace lending may involve multiple transfers of ownership, collection rights and investor rights and therefore a need for ongoing transparency and continuous access to data and documents supporting the loan collateral over the life cycle of a loan. In one aspect, the LVRS systems of the present disclosure enables Marketplace Lenders (“MPLs”) to provide investors access to a one-stop independent data and document repository to validate account-level information and, if needed, provide confidence to investors that the data and documents could be securely and efficiently moved to a backup server.

Individual and institutional investors may benefit from LVRS by receiving independent validation that each loan in a portfolio of loans is supported by the necessary data, documents and representations and warranties from the MPL without requiring the investor to access personally identifiable information (PII) on the account-level data or documents.

MPLs may be primarily marketing and servicing firms that connect borrowers with investors. The MPL may provide borrowers with access to an online loan application and may apply a credit risk analysis to project the riskiness of a loan. The loans are presented by the MPL to its network of investors, including individual and institutional investors. When a loan commitment is completed, a separate chartered Bank may originate the loan. After a relatively short period of time, e.g., two days, the loan may be re-purchased from the bank by the investors. The MPL may be the servicer of the loan and may provide services including processing borrower payments, collecting past due accounts and providing customer service to the borrower. The servicer may receive fees from the borrower's payments and returns principal and interest to the investors in accordance with the terms of the investment agreement.

In one aspect, a significant concept in this market is the ability of investors to purchase whole or fractional shares in individual loans. For example, individual investors may commit as little as $25 toward a specific loan that may have a total loan value of $5,000 or more. Prior to investing, investors can view certain anonymized attributes about a loan application. It is not practical, nor typically desirable, for MPL platforms to provide full consumer transparency to each investor since it might generate substantial risk of exposing sensitive personal information about a borrower to a large audience of actual or potential investors.

LVRS may be deployed, e.g., by the MPL, to efficiently bridge the gap between an investor's need for transparency and validation with the market and regulatory need to protect confidentiality of an individual borrower's PII. LVRS may enable access to supporting documents for all MPL investors, i.e., LVRS supports account-level validation needs of institutional investors purchasing large numbers of whole loans as well as individual investors purchasing small numbers of fractional loans.

In one aspect, all new accounts are “registered” in LVRS at origination by the MPL, i.e., as investors commit to fund an account, information about the account, the borrower and the supporting origination documentation may be electronically transferred to LVRS by the MPL, e.g., via a secure web service. Data and documents can be included as individual account files or batch files containing many separate accounts. Each file has a unique file mapping or index schema to identify the content or metadata of the file. An exception process ensures only accounts meeting LVRS criteria are processed, e.g., the data entries are complete and within an expected value range. Accounts failing to meet these criteria may be returned to the submitting MPL for correction.

TABLE 1 shows examples of account level documents that may be stored by LVRS such as in database 320 may include the following:

TABLE 1

Loan Agreement
Non-Negotiable Promissory Note
Terms of Use
Borrower Membership Agreement
Truth in Lending Disclosure
Borrower Credit Profile Authorization
Borrower Bank Account Verification
Applicable Privacy Notice
Security Agreement
Personal Guaranty
Uniform Commercial Code (UCC) Financing Statement(s)

For account data meeting LVRS criteria, LVRS may create a GDR Number (GDRN) for each loan account. The GDRN includes information that identifies the lender, the loan type, the origination date of the loan and the loan number assigned by the lender. This process may occur after the system verifies that the account is unique (not a duplicate) and that all of the required data and documents are in LVRS. Only complete accounts may receive a GDRN. Separate GDRNs may be created for multiple accounts in a file of new accounts. The GDRN information may be returned to the servicer by LVRS and can be used in subsequent file submissions to match new data to a registered account in LVRS. The GDRN may also be a number that can be shared with investors since it is independent of the account number or other PII and therefore has no security risk for the borrower.

With each LVRS registration file it processes, LVRS may generate a Registration Report. A file for new registrations may include a single account or a file with many accounts. For the processed file, the MPL may execute an electronic signature affirming certain representations and warranties related to all of the account information provided to LVRS in that file. The MPL may sign a single document for the file of accounts. A record custodian may also execute an electronic signature in the Registration Report acknowledging receipt of the information.

The following TABLE 2 is an example list of affirmations that may be made by the MPL as servicer to the original creditor for a file of newly originated accounts to be Registered in LVRS:

TABLE 2
The original creditor is the sole legal, beneficial and equitable owner of
each of the referenced loans or debt instrument and has good and
marketable title for each
Each loan or debt instrument is free and clear of any lien, pledge, charge,
claim, security interest or other encumbrance
The original creditor has not sold, assigned or otherwise transferred any
right in or to any loan or debt instrument
The original creditor has not pledged any loan as collateral for any debt or
other purpose except as agreed to by buyer
Each loan complies with Applicable Laws in all material respects,
including, without limitation:
The Federal Truth in Lending Act (and Regulation Z of the
Consumer Financial Protection Bureau)
The Equal Credit Opportunity Act and Regulation B of the
Consumer Protection Bureau)
Federal Trade Commission Act
All applicable state and federal securities laws
All applicable usury laws
Title V of the Gramm Leach Bliley Act of 1999, as amended and
any implemented regulations
The Fair Credit Reporting Act
Electronic Signatures in Global and National Commerce Act and
any laws related to the electronic execution of documents and
instruments
The Electronic Funds Transfer Act
No borrower of these loans or debt instrument has asserted any defense,
counter claim, offset or dispute
Each loan or debt instrument is free from any defense, offset, counterclaim
or recoupment that could be asserted by the borrower
No loans or debt instruments are in default or delinquent by more than 30
days (or other predefined time period)

In one aspect, the LVRS may systemically link the executed Registration Report to each account in the file. The Registration Report may become a permanent document attached to each account. From that point forward, accounts that were part of the same registration may have different changes in status or ownership, i.e., accounts that were not registered at the same time can later be grouped in a debt sale or securitization and each account in that debt sale or securitization file may have its own unique registration data and report.

In one aspect, the LVRS may provide the MPL a platform for continuous updates to data and documents on a registered account. For example, MPLs can upload statements, borrower correspondence, audio files of collection contacts or other “media” to a registered account. The information can be saved permanently to the account profile, or deleted at time frames determined by the MPL. In one aspect, the MPL can identify specific investors for an account, including identification of multiple investors for accounts with fractional ownership.

In one aspect, the LVRS may enable identified investors to securely view certain non-PII information about its portfolio of loans. For example, LVRS enables an investor with a portfolio of accounts to view a summary report indicating information such as the number and percentage of accounts with or without certain documents that could be required for collection of the balance due. The borrower could generate exception lists of GDRNs that it could provide to the MPL for service inquiries. For example, if certain accounts displayed risk due to a lack of documentation or other attributes, the investor could provide the list of GDRNs to the MPL without having any direct view of the borrower's PII or the account numbers.

In one aspect, investors can use LVRS for various functions including independent validation of representations, warranties and covenants of its investment agreements.

In one aspect, the MPL can enable access to non-PII data by other third parties for certification or regulatory purposes. For example, if a MPL or investor is seeking a rating agency report for a portfolio of accounts it can use LVRS to compile independent reports related to the specific accounts being rated and submit LVRS non PII validation data to the rating agency for that specific portfolio of accounts.

In one aspect, if a registered account in LVRS is sold by the MPL or investor to a debt buyer, LVRS may track that transfer of ownership and can enable the new owner to instantly have access to all of the account level data and documents stored in LVRS for those accounts.

In one aspect, the LVRS may retain records of any debt sales enabling an investor to retain information about an account up until it was sold for future analysis or reconciliation.

In one aspect, the LVRS may be universal and can be used by any MPL or investor for any loan type. It supports any type of data or document, in any data or document format or size. All information may be searchable at the account level using multiple search criteria and filters.

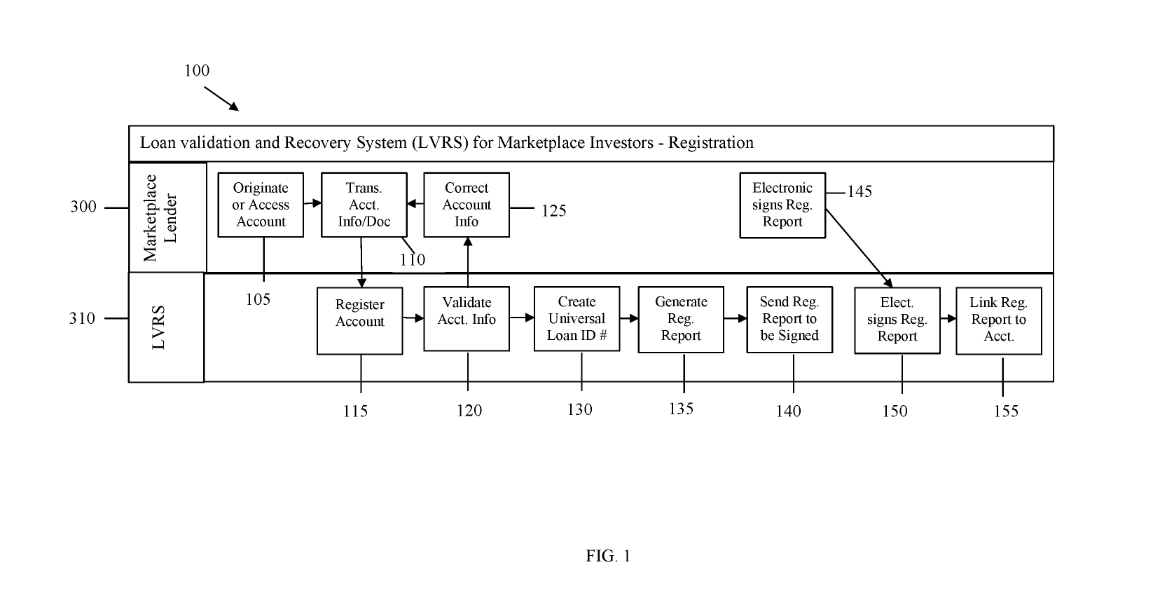

FIG. 1 is an example flow diagram 100 of registration related to loan validation and recovery, according to principles of the disclosure. At step 105, a MPL at MPL device 300 may originate (while acting on behalf of an original creditor) or access an account related to a consumer debt instrument or loan associated with a debtor or borrower.

At step 110, the MPL at MPL device 300 may transfer account information and documentation related to the account. At step 115, the LVRS service 310, which may comprise a computer and/or server, may register the account. At step 120 the LVRS service 310 may validate the account information. If any account information is deemed invalid, then at step 125 the MPL at MPL device 300 may correct the account information. If the account information is deemed valid, then at step 130, the LVRS service 310 may create a GDRN for the account. At step 135, the LVRS service 310 may generate a registration report which may include the GDRN. The registration report may include relevant details of the account such as, e.g., debt originating details including date, amount, collateral, original balance, current balance and the like.

At step 140, the LVRS service 310 may send the registration report to the MPL, perhaps via MPL device 300, to be signed. At step 145, the registration report including one or more affirmations, as previously described in relation to TABLE 2, may be signed by the MPL, such as electronically signed at MPL device 300. At step 150, the signed registration report may be returned for signature by the LVRS service 310, which may electronically sign the registration report. At step 155, the signed registration report may be linked to the account.

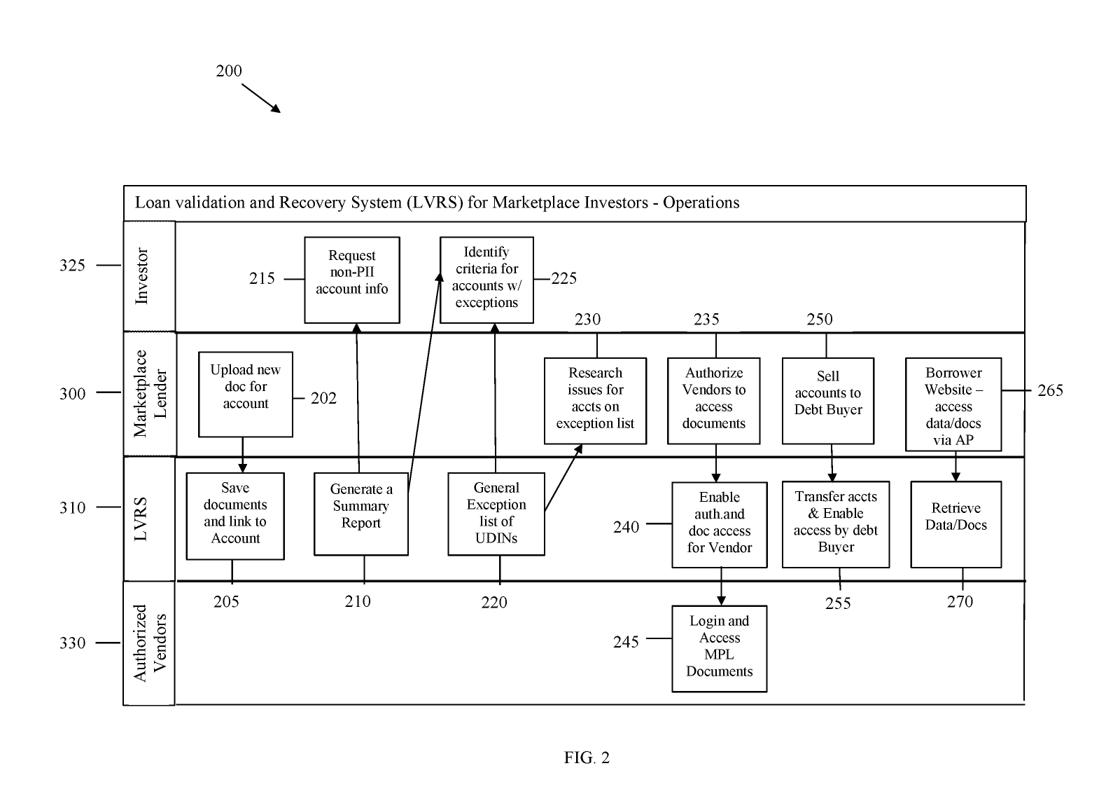

FIG. 2 is an example block diagram 200 and example process for loan validation and recovery for marketplace investors, according to principles of the disclosure. At step 202, an MPL at MPL device 300 may upload new documentation for the registered account, as set up in the process of, e.g., FIG. 1 and TABLE 1. At step 205, the LVRS service 310 may save the new documents into the account, e.g., at database 320. At step 210, the LVRS service 310 may generate a summary report of the account. At step 215, an investor at an investor device 325 may request non-PII account information of the generated report. At step 220, the LVRS service 310 may generate an exception list of GDRNs and convey to the MPL at MPL device 300.

At step 225, the investor at investor device 325 may identify criteria for accounts with exceptions. At step 230, the MPL at MPL device 300 may research issues for accounts on the exceptions list. At step 235, the MPL at MPL device 300 may authorize one or more vendors to access the documents.

At step 240, the LVRS service 310 may enable authentication and documents access for the one or more vendors at one or more vendor devices 330. At step 245, the authorized vendors at one or more vendor devices 330 may log into the LVRS 310 to access MPL documents. At step 250, the MPL or investor at MPL device 300 may sell one or more accounts to a debt buyer. At step 255, one or more accounts may be transferred to enable access by the debt buyer. At step 270, the LVRS service 310 may retrieve the data and documents to support the request received and provide them to the requestor.

FIGS. 1 and 2 may also represent a block diagram of the components for performing the respective steps of the process of FIGS. 1 and 2. The components may be software modules that when read from a non-transitory computer-readable media and executed by a computer, e.g., a server or LVRS server, are configured to perform the respective steps. The software modules stored on the computer-readable medium may comprise computer program product. The computer-readable media may comprise, e.g., a memory, a disc, a DVD, a CD, a thumb-drive, or an electronic storage medium.

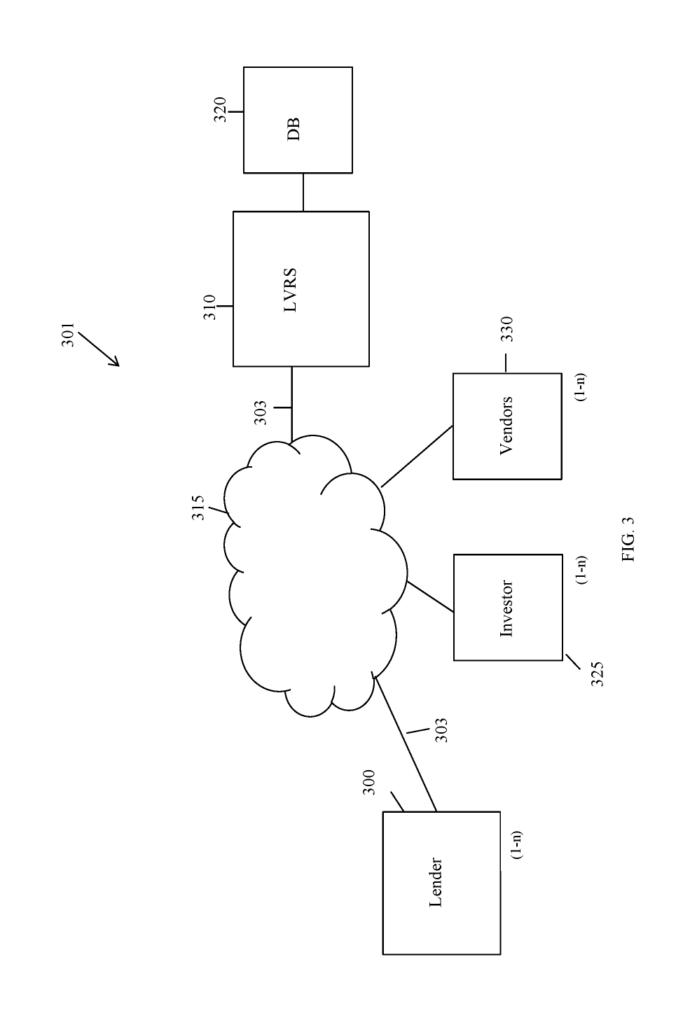

FIG. 3 is an example block diagram of an illustrative computer-based system 301 suitable for performing the processes of FIGS. 1 and 2, configured according to principles of the disclosure. The computer-based system 301 may comprise one or more lender devices 300, e.g., a computer, personal computer or a mobile computing device, for use to access the LVRS service 310 by one or more lenders. The system 301 may further comprise one or more investor devices 325, e.g., a computer, personal computer or a mobile computing device, for use by one or more investors to access the LVRS 310 service. The system 301 may further comprise one or more vendor devices 330, e.g., a computer, personal computer or a mobile computing device, for use by one or more vendors to access the LVRS 310 service. A network 315, such as, e.g., the Internet, may permit electronic communication via communication links 303 from the LVRS service 310 and one or more lender devices 300 with one or more investor devices 325 and one or more vendor devices 330. The LVRS service 310 may comprise a server. The LVRS service 310 may be coupled to a database 320 for storing the various accounts and documents described herein, and for retrieval of account information and associated documents as described herein.

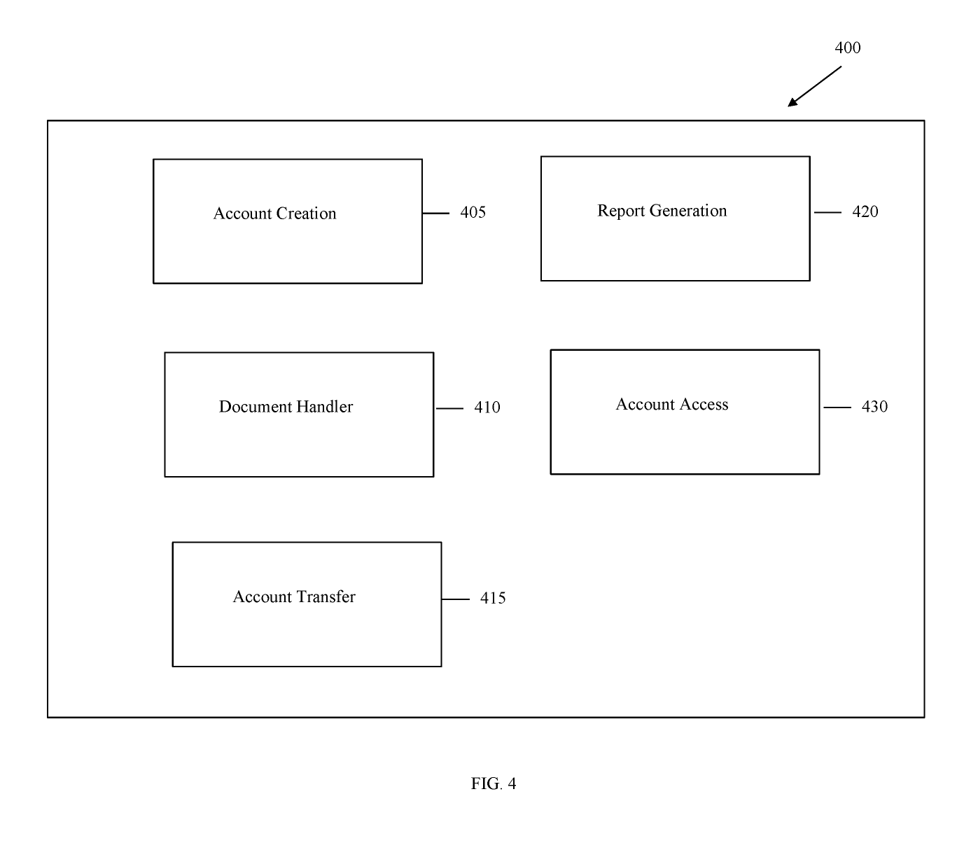

FIG. 4 is an example block diagram of software system 400 configured to provide loan validation and recovery for marketplace investors, according to principles of the disclosure. The software system 400 may comprise a plurality of subsystems 405, 410, 415, 420 and 430, configured to execute on suitable computing hardware, such as a server. The accounts creation subsystem 405 may provide the controls and functionality to permit a new account to be created. An MPL at MPL device 300 may originate the account on behalf of the original creditor. The accounts creation subsystem 405 may provide the functionality to perform, e.g., steps 105, 110, 115, 125 and 135. The report generation subsystem 420 may provide the functionality to perform, e.g., steps 135, 140, 145, 150 and 155. Document handler 410 may provide the functionality to perform, e.g., steps 202, 205 and 210. Account access 430 subsystem may provide the functionality to perform, e.g., steps 215, 220, 225, 230, 235, 240, 245, 265 and 270. Account transfer subsystem 415 may provide the functionality to perform, e.g., steps 250 and 255. In some embodiments, the various steps of FIGS. 1 and 2 may be associated with other subsystems.

In one aspect, a MPL at MPL device 300 and one or more vendors at vendor device 330 may simultaneously access the system 301 if each user is authorized to access the account. Moreover, one or more MPLs at MPL device 300 and one or more vendors at vendor device 330, one or more investors 325, in any combination, may simultaneously access one or more accounts at the database 320. Moreover, one or more MPLs at MPL device 300 and a one or more vendors at vendor device 330, and investors 325, in any combination, may simultaneously access the same account at the database 320.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A system for loan validation and recovery, comprising:
a server comprising a computer and connected to a network;
a database accessible by the server;
an account creation subsystem executing on the server that permits a marketplace lender (MPL) to establish at least one account related to at least one debt instrument of a debtor and to supply for the at least one account supporting data related to the at least one debt instrument, the account and supporting data stored in the database along with a GDR number (GDRN) for the at least one account;
a report generation subsystem executing on the server that permits a marketplace lender to electronically sign a report generated by the report generation subsystem affirming information within the generated report for the at least one account;
an account transfer subsystem executing on the server that permits a marketplace lender or owner of a loan to transfer ownership of the at least one account to a debt buyer, investor or trust; and
an account access subsystem executing on the server that permits the marketplace lender, the debtor and an investor to access the database and the at least one account.

2. The system of claim 1, wherein a plurality of: the MPL, the debtor, an authorized vendor and the investor can access the database simultaneously.

3. The system of claim 1, wherein an authorized vendor or the investor can access the at least one account only after being authorized at the server by the marketplace lender.

4. The system of claim 1, wherein the market place lender electronically signs the report to affirm at least one of the following affirmations:
a) that the marketplace lender or original creditor is the sole legal, beneficial and equitable owner of each of the referenced debt instrument and has good and marketable title for each referenced debt instrument,
b) each debt instrument is free and clear of any lien, pledge, charge, claim, security interest or other encumbrance,
c) the MPL or original creditor has not sold, assigned or otherwise transferred any right in or to any debt instrument,
d) the MPL or original creditor has not pledged any debt instrument as collateral for any debt or other purpose except as agreed to by the debt buyer,
e) no borrower of the debt instrument has asserted any defense, counter claim, offset or dispute,
f) each debt instrument is free from any defense, offset, counterclaim or recoupment that could be asserted by the debtor, and
g) the debt instrument is not in default or delinquent by more than a predetermined time period.

5. The system of claim 4, wherein the market place lender electronically signs the report to affirm each of the affirmations.

6. The system of claim 1, wherein MPL authorizes at the server an investor to have access to the at least one account and supporting data without access to personally identifiable information of the debtor.

7. The system of claim 1, further comprising a document handler subsystem that permits a MPL to upload new documents to the database and to link the new documents to the at least one account.

8. The system of claim 1, wherein the account access subsystem permits the investor to retrieve the new documents after the MPL has uploaded the new documents to the database.

9. The system of claim 1, wherein the at least one account comprises a plurality of accounts.

10. The system of claim 1, wherein the supporting document data comprise one or more of:
a) a Loan Agreement,
b) a Non-Negotiable Promissory Note,
c) a Terms of Use document,
d) a Borrower Membership Agreement,
e) a Truth in Lending Disclosure,
f) a Borrower Credit Profile Authorization,
g) a Borrower Bank Account Verification,
h) an Applicable Privacy Notice,
i) a Security Agreement,
j) a Personal Guaranty, and
k) a Uniform Commercial Code (UCC) Financing Statement.

11. A computer program product embodied on a non-transitory storage medium that, when read and executed by a computer, performs the steps for loan validation and recovery, comprising:
creating by marketplace lender (MPL) over a network at a server at least one account related to at least one debt instrument of a debtor and receiving at the server supporting data related to the at least one debt instrument, the account and supporting data stored in a database along with a GDRN for the at least one account;
receiving an electronic signature at the server that indicates that a MPL affirms information within a generated report for the at least one account;
transferring ownership at the server of the at least one account to a debt buyer, investor or trustee; and
permitting the marketplace lender and an investor to access the at least one account in the database.

12. The computer program product of claim 11, wherein a plurality of: the MPL, an authorized vendor and the investor can access the database simultaneously.

13. The computer program product of claim 11, wherein the authorized vendor and the investor can access the at least one account only after being authorized at the server by the marketplace lender or owner.

14. The computer program product of claim 11, wherein the electronical signature indicates at least one of the following affirmations:
a) that the MPL or original creditor is the sole legal, beneficial and equitable owner of each of the referenced debt instrument and has good and marketable title for each referenced debt instrument,
b) each debt instrument is free and clear of any lien, pledge, charge, claim, security interest or other encumbrance,
c) the MPL or original creditor has not sold, assigned or otherwise transferred any right in or to any debt instrument,
d) the MPL or original creditor has not pledged any debt instrument as collateral for any debt or other purpose except as agreed to by the debt buyer,
e) no borrower of the debt instrument has asserted any defense, counter claim, offset or dispute,
f) each debt instrument is free from any defense, offset, counterclaim or recoupment that could be asserted by the debtor, and
g) the debt instrument is not in default or delinquent by more than a predetermined time period.

15. The computer program product of claim 14, wherein the electronic signature indicates affirmation of each of the affirmations.

16. The computer program product of claim 11, further comprising receiving at the server an authorization from the MPL that authorizes the investor to have access to the at least one account and the supporting data without access to personally identifiable information of the debtor.

17. The computer program product of claim 11, further comprising receiving new documents at the server from the MPL to the database and to link the new documents to the at least one account.

18. The s computer program product of claim 11, further comprising permitting the investor to retrieve the new documents from the server after the MPL has uploaded the new documents to the database.

19. The computer program product of claim 11, wherein the at least one account comprises a plurality of accounts.

20. The system of claim 11, wherein the supporting document data comprise one or more of:
a) a Loan Agreement,
b) a Non-Negotiable Promissory Note,
c) a Terms of Use document,
d) a Borrower Membership Agreement,
e) a Truth in Lending Disclosure,
f) a Borrower Credit Profile Authorization,
g) a Borrower Bank Account Verification,
h) an Applicable Privacy Notice,
i) a Security Agreement,
j) a Personal Guaranty, and
k) a Uniform Commercial Code (UCC) Financing Statement.
